(19) United States
(12) Patent Application Publication
(10) Pub. No.: US 2020/0370960 A1
(43) Pub. Date: Nov. 26, 2020

(54) SPECTRAL IMAGING SYSTEMS, DEVICES AND METHODS

(71) Applicants: Avraham Barak, Beer Yaakov (IL); Commart Technologies 97 Ltd., Lod (IL)

(72) Inventor: Avraham Barak, Beer Yaakov (IL)

(21) Appl. No.: 16/881,034

(22) Filed: May 22, 2020

(30) Foreign Application Priority Data
May 23, 2019 (IL) 266863

(51) Int. Cl. G01J 3/28; G01J 3/02; G01J 3/26

(52) U.S. Cl. CPC G01J 3/2823; G01J 3/0227; G01J 3/0289; G01J 3/0208; G01J 3/2803; G01J 3/26

(57) ABSTRACT

A method for remotely sensing a change in one or more transmission characteristics of an EM radiation propagation medium through which EM radiation propagates that is radiated from one or more objects in a scene, the method comprising: providing a spectral imager comprising a tunable notch filter; capturing, by the imager, a plurality of scene images for each one of at least two notched bands; comparing a value relating at least one captured image with a value relating to at least one value relating to at least one other captured image to determine the presence and/or a location of changes in the imaged scene.

### TECHNICAL FIELD

Aspects of the present disclosure relate in general to remote sensing including, for example, to remote sensing with spectral imaging devices, systems and methods.

### BACKGROUND

The use of spectral imaging and analysis to detect and identify different material is well established. Spectral imaging combines imaging capability with spectral information to provide solutions in a variety of applications. Spectral imaging and analysis may be employed, for example, in the field of homeland security to detect uncontrolled emission of hazardous materials, gases and/or aerosols as a result of, for example, terrorist attacks, missile strikes, or natural disasters; in the field of industrial environment control to monitor the production, storage, transportation and use of hazardous materials; gas and/or aerosol to detect unintentional leaks for the protection of employees and/or nearby populations. Defense applications of spectral imaging and analysis can include, for example, monitoring a region for the detection of materials, e.g., in the field of chemical warfare.

Some existing spectral imaging systems such as spectral imager make use of a band pass filter (BPF) and a detector for determining characteristics of a medium (also: propagation medium) through which electromagnetic (EM) propagates when imaging a scene.

As shown schematically in FIG. 1, a scene 10 includes any objects 12 passively emitting and/or reflecting EM radiation. In addition, scene 10 includes a medium 14 (e.g., the atmosphere) through which EM radiation 20 propagates when imaging object 12. Changes in characteristics of EM radiation 20 propagating through medium 14 may be indicative of changes of the latter. A spectral imager 30 is operable to detect changes in EM radiation radiated from scene 10. For example, spectral imager 30 operable to detect and analyze changes in EM radiation received from scene 10 due to EM radiation absorption and/or scattering caused by the appearance of a cloud 16 in medium 14.

A spectral imager 30 may comprise a bandpass filter 32 and an EM radiation sensor 34 operable to sense EM radiation radiated from scene 10 and which is within the field of view (FOV) of spectral imager 30. Spectral imager 30 may receive only wavelengths of interest (λ_{0(T)}, λ_{1(T)}, . . . , λ_{n(T)}) radiated from object 12 and transmitted through the bandpass filter 32 for detecting and analyzing changes in propagation medium 14.

Where cloud 16 includes a specific material, characteristics of the received EM radiation 20 changes at specific wavelengths according to the absorption and/or scattering characteristics of the material in cloud 16. Spectral imager 30, using for comparison previously captured EM radiation from scene 10 when there was no cloud 16 present in medium 14, detects for example changes in the captured radiation intensity for one or more imaged wavelengths and may compare these changes to known absorption spectra to determine the composition of cloud 16.

Bandpass filter 32 may sweep through a wavelength band of interest for generating a 2D image that is descriptive of received EM radiation 20 by EM radiation sensor 34 in the FOV of spectral imager 30 for each one of a plurality of wavelengths in the wavelength band of interest, for example, to create a data cube. Based on sensed changes in received EM radiation intensity for the plurality of wavelengths, the material present in cloud 16 may be determined. As shown in FIG. 1, EM radiation sensor 34 detects selected wavelengths transmitted through bandpass filter 32 for performing spectral analysis.

The description above is presented as a general overview of related art in this field and should not be construed as an admission that any of the information it contains constitutes prior art against the present patent application.

### BRIEF DESCRIPTION OF THE FIGURES

The figures illustrate generally, by way of example, but not by way of limitation, various embodiments discussed in the present document. For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. References to previously presented elements are implied without necessarily further citing the drawing or description in which they appear. The figures are listed below.

FIG. 1 is a block diagram illustration of a spectral imager imaging a scene, as known in the art;

FIG. 2A is a block diagram illustration of a spectral imager imaging a scene, according to some embodiments;

FIG. 2B is a notch filter plot at various wavelengths;

FIG. 3 is a block diagram illustration of the spectral imager, according to some embodiments;

FIG. 4 is a flowchart of a method for imaging a scene, according to some embodiments;

FIG. 5 is a schematic illustration of a tunable notch filter, according to some embodiments;

FIG. 6 is a schematic cross-sectional side view illustration of a tunable notch filter and actuator, according to some embodiments;

FIG. 7 is an exploded view of the tunable notch filter and actuator of FIG. 6;

FIG. 8 is an assembled view of the tunable notch filter and actuator of FIG. 6;

FIG. 9 is a schematic cross-sectional side view of a tunable notch filter and actuator, according to some other embodiments;

FIG. 10 is an exploded view of the tunable notch filter and actuator of FIG. 9;

FIG. 11 is another schematic cross-sectional side view of the tunable notch filter and actuator of FIG. 9;

FIG. 12A is a schematic illustration of an optical design of a spectral imager, according to some embodiments; and

FIG. 12B is a schematic illustration of an optical design of a spectral imager, according to some other embodiments.

### DETAILED DESCRIPTION

The following description of the spectral imaging devices, systems and methods is given with reference to particular examples, with the understanding that such devices, systems and methods are not limited to these examples.

Aspects of embodiments pertain to the imaging of a scene through a medium (e.g., the atmosphere) to detect changes in the medium, such as the unexpected and/or undesired appearance of a cloud in the atmosphere.

A cloud that is in the propagation medium may change the electromagnetic radiation (EM) transmission characteristics of the medium (e.g., atmosphere) and, therefore, the intensity and/or other characteristics of one or more wavelengths of EM radiation received from the scene. Transmission characteristics can pertain to absorption and/or scattering of received scene EM radiation. Scene EM radiation can include passively emitted EM radiation and/or reflected EM radiation. Reflected EM radiation may be produced by artificial and/or natural light sources.

Passive electromagnetic emission characteristics of the imaged scene may be measured when there is no cloud present in the medium. Hence, changes in the electromagnetic absorption characteristics of the atmospheric medium may provide an indication of the presence of a gas cloud, aerosols (e.g., droplets and/or particles); and/or the like in the propagation medium.

To simplify the discussion that follows it is assumed that the temperature of a cloud is the same as that of the surrounding medium and that any passive EM emission by the cloud, if present, is not considered for detecting and analyzing the cloud material. Hence, in principle, only the scene EM radiation radiated by the objects (passively and/or actively) may be considered when monitoring the medium for detecting changes in the EM transmission characteristics of the medium which manifest themselves in sensed scene EM radiation characteristics. Changes in sensed scene EM radiation characteristics may relate to changes in sensed irradiation intensity profiles at one or more wavelengths. Based on the measured changes in a sensed irradiation intensity profile, the presence of a cloud in a medium may be determined as well as the cloud characteristics. Alternatively, the cloud may be of a different temperature to the surrounding medium, and any EM emission by the cloud, if present, is considered for detecting and analyzing the cloud material. It should be appreciated that detection and analysis of a cloud that is at the same temperature as the surrounding medium as described herein may be more difficult than detection and analysis of a cloud that is at a different temperature to the surrounding medium.

The use of a bandpass filter for analyzing wavelengths of interest transmitted through the bandpass filter for determining what caused changes in the EM radiation propagation medium may pose some technical limitations. For example, comparatively low levels of radiation reach the detector as a result of filtering the entire spectrum out aside for a selected band. The bandpass filter-based approach may thus require the employment of comparatively expensive and complex detectors (e.g., cooled detectors) to overcome signal-to-noise related limitations. Further, the captured images may be of comparatively low-quality making it difficult to reliably perform analysis of the data descriptive of the transmitted band.

As an alternative to the band pass filter, a notch filter may be used. Embodiments of notch filters include a single band notch filter, a plurality of single band notch filters, or a tunable notch filter. A single band notch filter is implemented, for example, by an optical element designed to create the notch filter effect. A single band notch filter may be employed to trace a specific absorption curve characteristic of one specific absorbing material characterized by that curve. Optionally, a plurality of single band notch filters may be employed for tracing a specific absorption line characteristic of a corresponding plurality absorbing materials characterized by these curves. These notch filters may transmit (as opposed to reflect) the notched wavelengths in the same manner as band pass filters. A limitation of single band notch filters may be that they are limited to specific wavelengths and further, are unable to scan through a complete band of interest. A notch filter may be a transmissive or reflective notch filter.

Aspects of embodiments disclosed herein relate to devices, systems and methods for spectral imaging of an environment for the detection, identification and/or analysis of characteristics of a cloud in the atmospheric medium, for example, by employing a notch-based imaging approach, e.g., as outlined herein. Such cloud can include, for example, a gas cloud and/or a cloud of aerosols, including for example, fuel droplets and/or dust particles. Cloud characteristics can include, for example, position estimation in an imaged scene, cloud composition, material concentration and/or volumetric spread of the cloud.

In some embodiments, a spectral imaging system comprises a spectral imager that includes a tunable notch filter for filtering EM radiation received from the scene; and an EM radiation sensor that is operably associated with the notch filter such that the EM radiation sensor can receive scene EM radiation reflected (as opposed to transmitted) from or by the notch filter. By using the structure of a Fabry-Perot Interferometer (FPI) adapted for reflecting (as opposed to transmitting) incoming EM radiation, the notch filter as described herein is rendered tunable, enabling scanning of a full band of interest. Clearly, alternative tunable notch filter techniques may be employed. The tunable notch filter may for example allow scanning a continuous, non-discrete, range of frequencies.

An FPI comprises two parallel partially reflecting surfaces (mirrors), herein referred to as a proximal and a distal surface. In use, the proximal surface is positioned proximal to the imaged scene and the distal surface is positioned further away from the scene to be imaged than the proximal surface. In some embodiments the tunable FPI-based notch filter is implemented by changing the gap between the mirrors using some form of actuator, for example.

Since reflected light is used, the actuator of the Fabry-Perot interferometer can be placed behind the distal surface, as no clear aperture is required for the detection of radiation transmitted through the notch filter. This structure enables a large aperture at the proximal surface, and better control of alignment between the surfaces. The notch filter may therefore be tuned to cover a broad range of absorption spectra as described below.

In the reflective notch filter-based approach disclosed herein, scene EM radiation comprising a range of wavelengths excluding the information of the tunable notched-out wavelength is reflected by the notch filter towards the EM radiation sensor. The detected reflected EM radiation thus includes all sensed scene EM radiation wavelengths aside from the selected notched wavelength, thus creating a notch filter effect for the range of received scene EM wavelengths. Correspondingly, employing a reflective notch filter for example by investigating light reflected from a bandpass filter may allow the implementation of a tunable notch filter, e.g., as disclosed herein.

The spectral imager can be operable to image the scene EM radiation that is, for example, in the long wavelength infrared range, the mid wavelength infrared range and/or the short wavelength infrared range. The EM radiation sensor of the spectral imager can be a cooled or uncooled thermal imaging sensor. In some embodiments EM radiation sensor is a micro bolometer detector. Optionally, EM radiation sensor has a sensitivity of 30 mK or better.

The spectral imager is operable to selectively notch out different wavelengths of incoming scene EM radiation for generating one or more sets of images descriptive of the characteristics of sensed EM radiation over the sensed range of wavelengths excluding the notched-out wavelength.

Merely to simplify the discussion that follows, without be construed in a limiting manner, the term “wavelength” as used herein may also encompass the meaning of the term “wavelength band”, which can be considered a wavelength band that is part of the range of sensed wavelengths. In some embodiments, the plurality of sets of data may be arranged as a “data cube”.

By operating in a hyperspectral mode, the spectral imager can, for example, detect the presence of a cloud in an investigated field of view and determine characteristics of the cloud based on its EM radiation transmission characteristics, which includes the cloud's absorption curves in the investigated FOV.

Detection of the presence of a cloud in a medium and determining characteristics of the cloud may be performed, in some embodiments, as outlined herein.

In some embodiments, cloud detection may be achieved by (e.g., continuously) capturing images from the scene for a selected wavelength band. The selected wavelength band may be scanned with a notch filter, for the purpose of detecting changes in EM radiation and evaluate the spectral characteristics relating to changes detected in a FOV of the scene.

At least one or more of the captured images may be referred to as “reference image data”, and at least one or more other image of the captured images may be referred to as an “observation image data”. A value relating to the reference image data may be compared with a value relating to the observation image data to obtain a comparison. In the description that follows, the expression “a value relating to the reference/observation image data” (as well as grammatical variations thereof) may herein also simply be referred to as “reference image” and “observation image”.

By comparing “reference” image data to “observation” image data of the captured images, a change in the image scene may be detected and the location of the change determined.

For a certain comparison a selection of the one or more captured images may be used as reference image data and another selection of the one or more captured images may be used as observation image data. For a later comparison in time, the other selection of captured images may be used as reference image data with respect to a further selection or designation of observation image data.

In some embodiments, the same image data of a captured scene may serve as a reference image for comparison with subsequently captured images of the scene. For example, the reference image data may remain “static” for a certain period of time. For example, a snapshot of a piping system may be taken every few hours, and the snapshot may be compared with later acquired images of the piping system.

Reference image data can relate to the long-term tracking of a region of interest of a scene, and observation image data can relate to the short-term tracking of a region of interest of the same scene. Alternatively, reference image data can relate to the short-term tracking of a region of interest of a scene, and observation image data can relate to the long-term tracking of a region of interest of the same scene.

Correspondingly, the expression “reference scene EM radiation” as used herein may pertain to EM radiation captured from a scene that is used as a basis for comparison to “observed scene EM radiation” captured in a time period after the capture of the reference scene EM radiation. Clearly, data relating to observed scene EM radiation may later become data which relates to reference scene EM radiation.

The scene EM radiation comprising EM radiation received through an EM radiation propagation medium that may or may not comprise “cloud”. The term “cloud” as used herein refers to any of a cloud of gas, and/or aerosol (e.g., particles, droplets). Optionally, the EM radiation propagation medium may be a vacuum.

Where the imaged scene does not include a cloud, the subsequent appearance of a cloud will alter the subsequently captured scene EM radiation, thus enabling detection and analysis of the cloud. Where an imaged scene already includes a cloud, the subsequent propagation, change of position, and/or concentration of the already-present cloud will alter the subsequently captured scene EM radiation, thus enabling detection and analysis of the cloud(s).

As already outlined herein, the plurality of scene images may be generated or captured for a corresponding plurality of selected different n notch filter configurations or positions (e.g., notch filter band). Each one of the captured scene images is descriptive of a momentary intensity profile of the scene, excluding a first selected wavelength or wavelength band.

Per notched wavelength, a selection of the plurality of captured images may be referred to as a “reference image data” and another selection as an “observation image data”.

In some embodiments, the plurality of captured scene images may be processed to obtain, respectively, per notched wavelength, reference and observation image data. The processing may be executed, for example, by applying, during the capturing of the plurality of scene images, averaging (e.g., rolling averaging), determining a medium, filtering (e.g., by applying a finite impulse response filter) and/or the like, to obtain, per notched wavelength, a plurality of reference and observation images. Optionally, the processing of images may comprise the detection and removal of outliers.

Accordingly, in some embodiments, per notched wavelength, the processing of the plurality of captured images may be performed in an “ongoing” manner, for each additionally captured image, and/or after a certain number of images was acquired. The above procedure may be repeated for different notched wavelengths, for example, in a sweeping manner, by applying different notch filter configurations, to obtain a group of image data.

The different tunable notch filter configurations are selected to sweep a selected wavelength range of scene radiation wavelengths operable to be sensed by the spectral imager to obtain a plurality of reference scene radiation intensity readings or measurements (also: reference intensity maps or images).

For each position k of the n notch positions, “k” (1<=k>=n), a plurality of images may be captured. At least one of the plurality of images may be used as a “reference image data” and at least one further image may be designated as “observation image data”.

“N1” designates the number of scene images taken for each “k” position, that can be used for obtaining the reference image data. In some embodiments, the N1 scene images may be processed, for example, by employing a weighted averaging and/or by employing FIR.

For example, reference image data, which may be represented as I_{ref}[i,j,k], may be obtained by processing N1 scene images, where “I” is an output representing a measured EM scene irradiance read by the EM radiation sensor for the specific pixel), where i,j represents the pixel index; and where k is the notch filter index for the respective notched-out wavelength of a wavelength range radiated from the scene and incident onto the EM radiation sensor.

Analogously, “N2” designates for each “k-th” position of the notch filter (and correspondingly notched wavelength), the number of captured images selected as observation images. The N2 observation images may be processed to obtain observation image data related to the specific “k-th” position I_{obs}[i,j,k].

Optionally, the one or more values relating to N1 reference images may be compared with one or more values relating to N2 observation images to determine if the comparison result meets a cloud detection criterion. Meeting the cloud detection criterion may provide an indication of the presence of a cloud in the EM radiation propagation medium, indicating that absorbance and/or scattering has taken place. If the cloud detection criterion is not met, it may be concluded, accordingly, that no cloud is present in the EM transmission

For example, for each notch (indicated by index “k”), the observation image data may be compared with the reference image data to obtain as a comparison result. The obtained result may be integrated across the different swept k notch filter positions to detect a change of scenery intensity, for each pixel and for each “k” filter position, e.g., as follows:

I_{diff}=[i,j,k]=I_{obs}[i,j,k]−I_{ref}[i,j,k] EQ. 1)

I_{gd}[i,j,k]=ΣI_{diff}[i,j,k] EQ. 2)

I_{gd} represents the global Intensity difference is the sum of all difference intensities for all “n” notch positions (i.e., integrated intensity differences).

In some other embodiments, the reference image data may be integrated across the various k notched wavelengths, and the observation image data may be integrated across the various k notched wavelengths, and the result of each one of the two integrations may be subtracted from each other to arrive at the comparison result.

Either way, if pursuant to performing the comparison (EQ. 2) a change in the imaged FOV is detected meeting a cloud detection criterion, along with the location of the change within the FOV, the results of EQ. 1 may be invoked to perform the spectral analysis of the ROI to characterize the material in the ROI.

Optionally, the comparison may be performed in a pixel-wise (or segment-wise) manner by comparing between pixel values at positions in a reference image with pixel values at respective positions in an observation image relating to a plurality of n notched reference and observation images of a selected remote sensing band. If there is an unexpected delta between respective pixels of the global reference and observation images, it can be concluded that there is occurrence of a cloud between an object in the scene and the spectral imager imaging the scene.

An overview of the positions of all such pixels meeting the cloud detection criterion provides an indication of the position and size of the cloud in the FOV of the EM radiation sensor.

Optionally, images may be manipulated or otherwise processed, for example, using an image segmentation algorithm such as but not limited to “superpixel” segmentation or blob segmentation to obtain “segmented” or “clustered” image data. In super-pixel segmentation, adjacent pixels are selected for generating a plurality of non-overlapping super-pixels. Additional or alternative pixel selection and/or processing methods may be employed.

In some embodiments, the processing of image data may be performed in an adaptive manner, for example, based on the captured scene information.

For example, parameters for the processing acquired images for obtaining reference and/or observation image data may be adaptively changed, for example, to selectively focus on or fast or slow changes in the captured scene information.

By summing images over “n” bandpass images, the equivalent intensity of one full band image is obtained, but this does not improve SNR as each image is of different band.

By summing up the intensities of all images in the dataset (reference image data or observation image data) over “n” notch positions, the resulting intensity can be expressed as ΣI_{Notch}≈Σ(I−I_{band})≈(n−1)*I. Hence, by summing images over “n” notched images you get the equivalent intensity of “(n−1) times full band image. Therefore, notch summation results in comparatively improved SNR due to repeated summation of nearly the same image.

The notch-filter based approach may thus allow for more reliable detection of changes in the EM transmission characteristics of the imaging medium of the scene than the bandpass-filter based approach, considering identical EM radiation sensor operating parameter values.

It should be appreciated that the summed notch values include the entire scene EM radiation repeated for “n” notch points (kₜₕ=1, . . . , n), minus the absorbed scene EM radiation due to the presence of one or more clouds in the EM propagation medium. Therefore, the SNR is \sqrt{n} times better than similar integral taken for a bandpass-based filter.

Optionally, the number of scene images selected to serve as a basis for reference images may be chosen to be equal or smaller than then number of N2 scene images selected to serve as observation images. Optionally, a ratio between N1 and N2 may range from 1:10˜1:100. The ratio between N1 and N2 may be selected based on a determined complexity of the imaged scene in the FOV of the spectral analyzer. For example, the ratio between N2 and N1 may be higher the greater the complexity of the imaged scene in the FOV of the spectral analyzer. Optionally, both N1 and N2 may increase the greater the complexity of the imaged scene in the FOV of the spectral analyzer. Optionally, an increase in N1 may be proportionally higher than an increase in N2. Optionally, an increase in N2 may be proportionally higher than an increase in N1.

In some embodiments, spectral absorbance analysis may be performed only for the specific pixels where a comparison in the pixel values indicates that the cloud detection criterion is met.

Spectral absorbance analysis may be based on the spectral absorbance curve defined as absorbance vs. wavelength and may be based on the plurality of sets of observation image readings taken when scanning or sweeping the scene spectral range. A spectral absorbance curve for a specific wavelength may be obtained by subtracting observation image data from reference image data for the same FOV for each notch position, representing a selected wavelength.

The notch filter described herein can therefore filter out specific (transmitted) wavelengths while reflecting the remaining radiated EM spectrum towards the EM radiation sensor. The result is that most of the EM radiation incident onto the notch filter also reaches the EM radiation sensor. This way, the quality of the imaging is not impaired as compared to bandpass solutions limited to EM radiation that is transmitted through the FP interferometer, while still providing spectral separation. This structure further enables the use of comparatively efficient, cost effective, and fast EM radiation sensing in the spectral imaging system as described herein since the collected signal strength is comparatively higher and there is therefore a better Signal-to-Noise as compared to the collected EM radiation for a bandpass FP interferometer system set up to capture the same target environment.

In use, the spectral imager is installed at a position suitable for sensing EM radiation for a monitored area to generate EM radiation data descriptive of the monitored area. Optionally, the monitored area can include but is not limited to an area where a (e.g., gas) cloud is more likely to be observed. Based on data descriptive of the collected EM radiation data, one or more characteristics of one or more clouds that are in the FOV of the sensed (also: imaged) scene of the EM radiation sensor can be determined.

In some embodiments the EM radiation sensor senses EM radiation that is received from the area of interest through the notch filter to generate EM radiation notch data values of sensed EM radiation data. The generated EM radiation notch data values are descriptive of a spectral band, excluding a selected band of interest. Optionally, EM radiation notch data values are processed, e.g., summed, averaged and/or otherwise manipulated, to generate processed EM radiation notch data values.

The EM radiation sensor has an imaging resolution described by an array of pixels having a fixed number of rows and columns of pixels. EM radiation data is collected per pixel.

Data descriptive of collected spectral absorbance curve is compared to data descriptive of known material spectral absorbance curves. In some embodiments, wavelength-dependent scattering effects may also be considered to determine characteristics of the detected cloud. However, merely to simplify the discussion that follows and without be construed in a limiting manner, the description may refer to absorption only.

Each material spectral absorbance curve relates the value of absorption per molecule per wavelength for a specific material such as a gas, also known as absorbance coefficient curve. Material spectral absorbance coefficient curves may be obtained provided from laboratory measurements and/or which may be publicly available. Data descriptive of material spectral absorbance coefficient curves may be stored in the spectral imager and/or in a device external to the spectral imager.

In some embodiments, spectral analysis may be performed, for the FOV in which a change is detected, by comparing between a spectral absorbance curve and the material spectral absorbance coefficient curve.

In an embodiment, the comparing can comprise generating a bandpass spectral image which can be obtained by subtracting the notch curves from the value without any notch.

Assuming knowledge of the background scene without the material to be detected, spectral analysis may be performed by (pixel-wise) subtracting, per notched k-th wavelength, background scene data values from the scene image comprising the cloud with the material to obtain a material spectral curve. The obtained curve is then compared with a library of known curves representing absorbance coefficient curves for different materials. This allow finding the curve that is most similar to the calculated curve by comparing shape only (regardless of absorbance specific value). Optionally, the comparison may be performed by employing general likelihood test ratio (GLRT) (for the ROI in the FOV).

In an embodiment, match-filtering may be employed for detecting the presence of a cloud and analyzing its content. It is noted that match-filtering assumes a random behavior of the background with statistics that can be known or estimated from measurements.

The result of the spectral absorbance analysis includes determining the type and concentration of material that is likely causing the absorbance. It is noted that the term “determining” may also include the meaning of the term “estimating”.

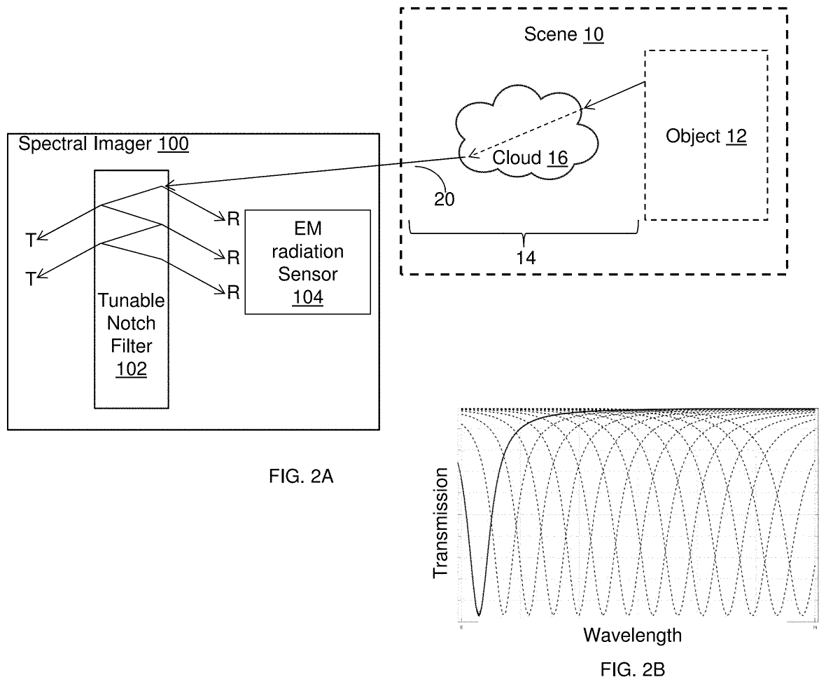

Referring now to FIG. 2A a spectral imager 100 comprises at least a notch filter 102 and an electromagnetic EM radiation sensor 104. Notch filter 102 may be based on the principles of an FPI and is operable to transmit and reflect scene EM radiation, which may propagate through a cloud 16, and EM radiation sensor 104 is operable to capture EM radiation reflected from notch filter 102 to selectively filter out specific transmitted wavelengths. For simplicity, reflected EM radiation is here represented as R and transmitted EM radiation is here represented as T but these representations should not be considered limiting. FIG. 2B shows notch filter plots for various notched wavelengths.

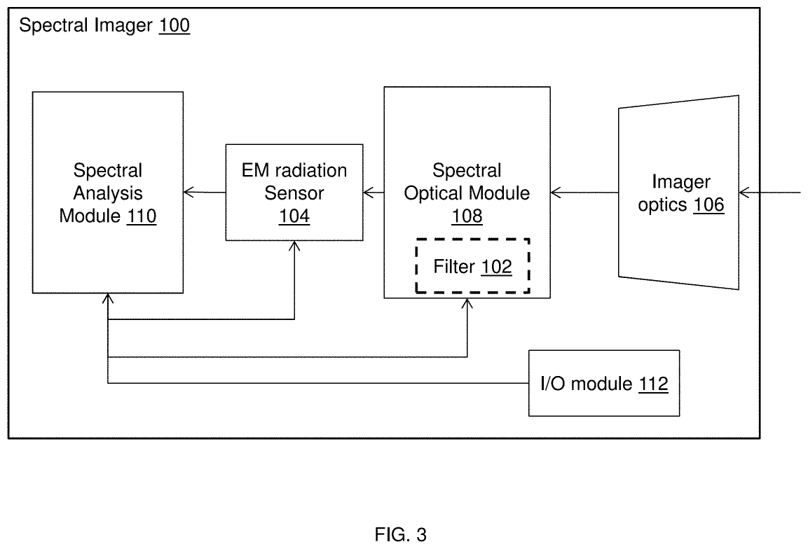

As shown in more detail in FIG. 3, spectral imager 100 may further comprise an imager optics 106 (e.g., an objective lens), a spectral optical module 108 and a spectral analysis module 110. Spectral optical module 108 may comprise notch filter 102. Spectral imager 100 optionally further comprises input/output module 112.

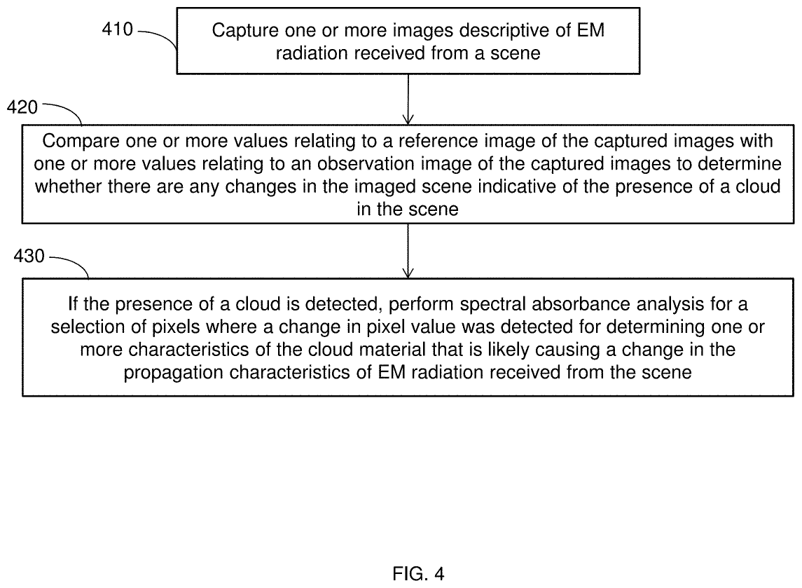

Further referring now to FIG. 4, a method for remote sensing may comprise capturing one or more images descriptive of EM radiation received from a scene with no cloud present (step 410). Optionally, a plurality of images may be captured by notching out one or more selected wavelengths of the spectrum of sensed wavelengths.

The method may additionally include, for example, comparing one or more values relating to a reference image of the captured images with one or more values relating to an observation image of the captured images to determine whether there are any changes in the imaged scene indicative of the presence of a cloud in the imaged scene (step 420).

The comparison may be performed, for example, by subtracting one or more values relating to one or more reference images from one or more values relating to one or more observation images.

Optionally, the comparison may be performed to determine if the outcome yields a result that meets a cloud detection criterion. For example, if, for a certain pixel value relating to a reference image and a corresponding pixel relating to an observation image the pixel difference value exceeds a certain magnitude, then it may be concluded that the same pixel images an FOV in which a cloud is present affecting the EM radiation propagation characteristics received at the spectral imager (e.g., through absorption and/or scattering).

The method may further include, if the presence of a cloud is detected, performing spectral absorbance analysis for a selection of pixels where a change in pixel value was detected for determining one or more characteristics of cloud material likely causing a change in the characteristics of EM radiation received from the scene (step 430).

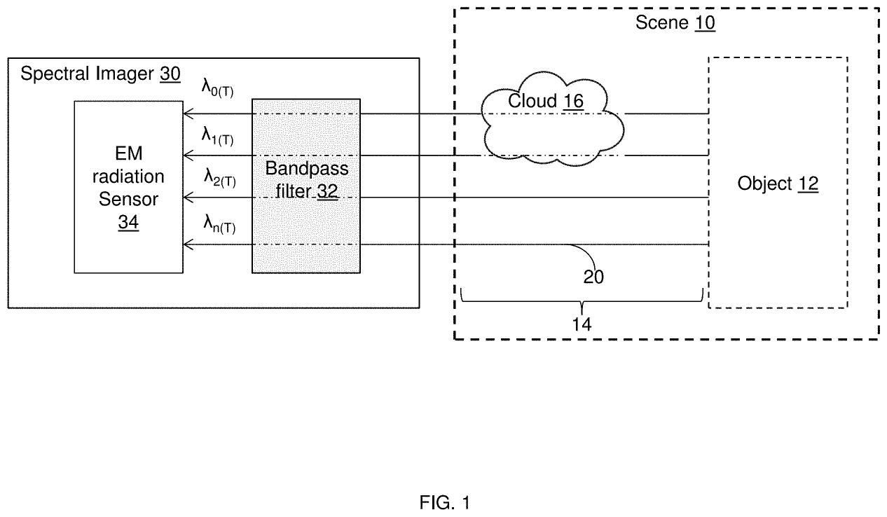

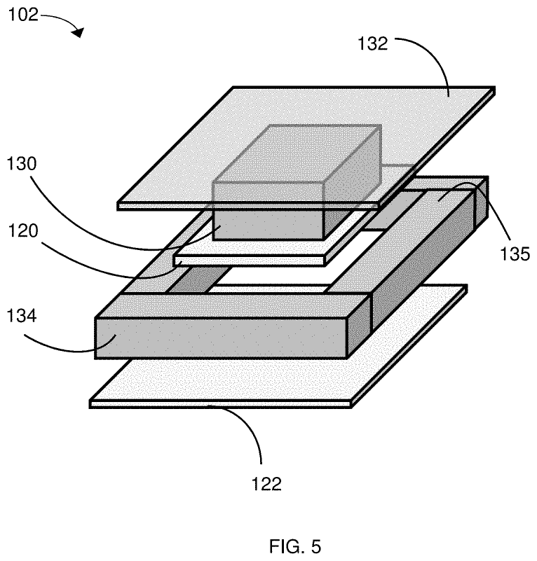

It should be appreciated that spectral imager 100 shown in FIG. 2A differs from spectral imager 30 of FIG. 1 primarily in the use of reflected EM radiation from filter 102 as opposed to transmitted EM radiation from bandpass filter 32. For example, with reference to FIG. 5, no clear distal aperture is required for the sensing of EM radiation transmitted through notch filter 102, thus allowing the positioning of a mirror positioning mechanism 130 such as an actuator behind the distal mirror 120. For example, actuator 130 can be arranged behind the distal mirror 120, of notch filter 102, i.e., downstream of the distal mirror 120 when viewed from scene 10. The mirror positioning mechanism 130 may be arranged in the optical path of transmitted EM radiation emanating from the notch filter 102. This structure enables a large aperture at the proximal surface 122, and better control of alignment between the distal 120 and proximal 122 mirrors.

Spectral analysis module 110 may comprise circuitry (e.g., controller, a memory and/or a controller) operable to execute instructions for determining characteristics of cloud 16. For example, spectral analysis module 110 may be operable to perform step 430 for analyzing captured EM radiation data, e.g., as outlined herein in more detail. For example, a processor executing instructions stored in the memory can perform spectral analysis, e.g., as described herein.

Spectral analysis module 110 may also be operable to control the operation of notch filter 102. For example, spectral analysis module 110 may be operable to control the operation of notch filter 102 to analyze (e.g., only) data relating to pixels that pertain to a detected cloud 16.

Spectral imager 100 may comprise an input/output module 112 such as, for example, a display, a data transfer interface (e.g., USB port and/or a wireless communication module), for enabling an operator to set control parameters of elements of the spectral imager such as imager optics 106, spectral optical module 108, EM radiation sensor 104, I/O module 112 and/or notch filter 102 and to share data cube information and analysis results.

As schematically illustrated in FIG. 5, one or more actuators 130 may be operably coupled with distal mirror 120 for controlling a distance between distal mirror 120 and proximal mirror 122. Actuator 130 may be mounted on a base 132. Proximal mirror 122 may be mounted on a frame 134. In some embodiments, base 132 may be mounted on the back side 135 of frame 134 such that distal mirror 120 and proximal mirror 122 face each other.

As actuator 130 is operably engaged, distal mirror 120 is moved closer to proximal mirror 122 or further away from proximal mirror 122 to thereby change the distance between distal mirror 120 and proximal mirror 122. Changing the distance between distal mirror 120 and proximal mirror 122 changes the wavelengths that are not reflected between the distal and proximal mirrors 120 and 122 and creating constructive/destructive interference, thereby notching out wavelengths which are not reflected from notch filter 102.

In some embodiments, notch filter 102 may have the following specifications: a mirror diameter of, e.g., 10-30 mm; a mirror reflectivity of, e.g., 85%-95%; a nominal gap of e.g., central wavelength/2*n, for example, 5 μm or 10 μm (in case of 10 μm central wavelength, the notch filter may be suitable for the detection of long wave infrared (LWIR) radiation in the region of 8-12.5 μm); a parallelism between mirrors of, e.g., +/−1 arcSec; a parallelism repeatability of, e.g., <1 arcSec; an actuator working Frequency of, e.g., at least 30 Hz; an actuator displacement range of, e.g., up to 20 μm displacement; an actuator displacement resolution of, e.g., 0.01-0.05 μm; and an actuator displacement repeatability of, e.g., 0.01-0.05 μm.

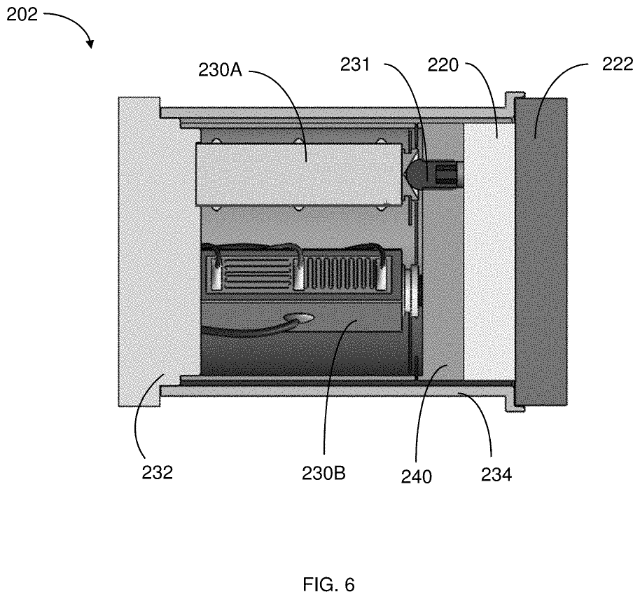

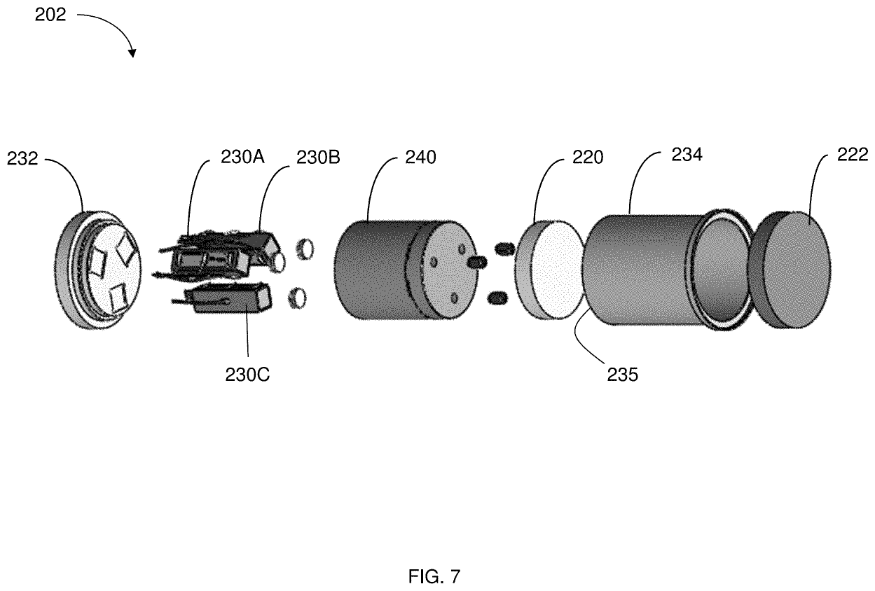

Reference is now made to FIGS. 6-8 illustrating a notch filter 202, which is an embodiment of notch filter 102. Optionally, notch filter 202 may have a cylindrical shape. According to some embodiments notch filter 202 comprises a distal mirror 220 and a proximal mirror 222. Distal mirror 220 is operably coupled with one or more (e.g., piezoelectric) actuators 230 that may be mounted on a base 232. In some embodiments three actuators 230A, 230B, and 230C are provided. In some embodiments, actuator 230 may include a strain gauge (not shown) for measuring the displacement of actuator 230 for closed loop control. Additional or alternative arrangements enabling closed loop control may be employed. Actuators 230 may comprise mounting pins 231 for operably mounting distal mirror 220 thereon.

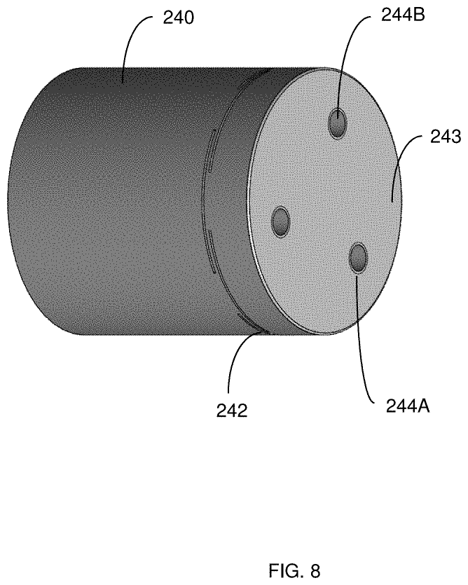

Notch filter 202 may further comprise a mount casing 240 that defines an open cavity that is open on a bottom end thereof. Mount casing 240 may be disposed within an outer sleeve body 234. Mount casing 240 comprises mounting holes 244 in upper surface 243 for insertion of mounting pins 231 of actuators 230. Slits 242 create a spring out of the mount casing 240 to enable elongation of casing 240 as actuators 230 push the casing. Slits 242 may be placed on the body of casing 240 as shown in FIG. 8 or on the face of the casing (not shown). Distal mirror 220 may be mounted on the upper surface 243 of inner mount casing 240 and proximal mirror 222 may be mounted such to enclose an open cavity of outer sleeve body 234. Optionally, proximal mirror 222 may be arranged on a seating collar radially extending from the front opening of outer sleeve body 234.

Base 232 may be mounted on the bottom 235 of enclosing outer sleeve body 234 with actuators 230, mount casing 240, and distal mirror 220 arranged in mount casing 240 such that distal mirror 220 and proximal mirror 222 face each other. As actuators 230 are operably engaged, for example, such that distal mirror 220 is moved closer or further away from proximal mirror 222 to thereby change the distance between distal mirror 220 and proximal mirror 222 to thereby change the wavelength that is not reflected between distal and proximal mirrors 220 and 222 and reflected out of proximal mirror 222 towards EM radiation sensor 104.

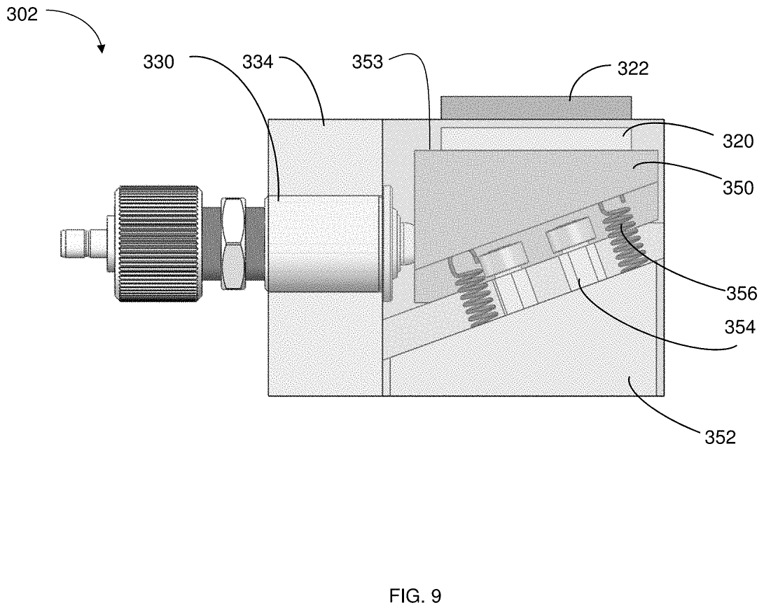

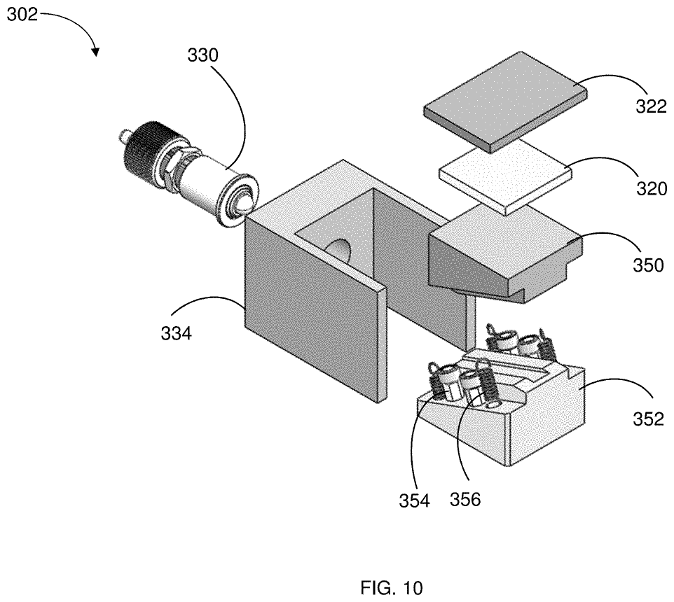

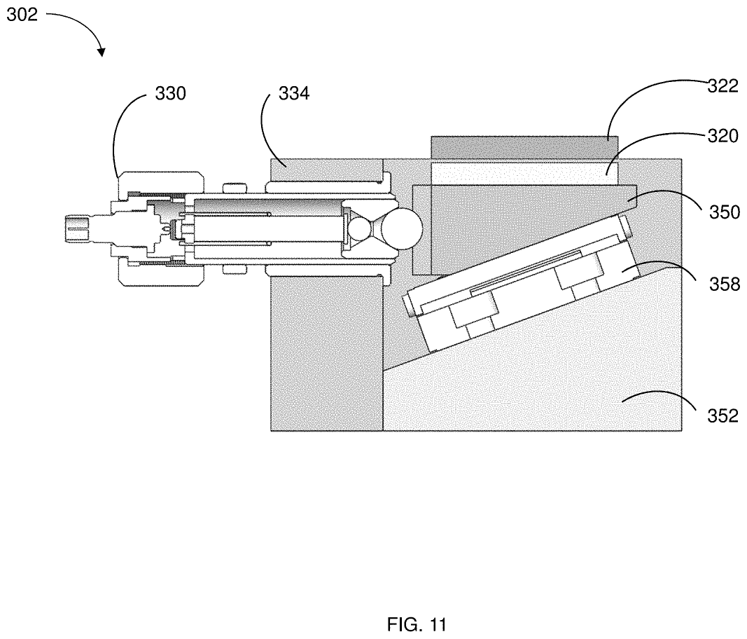

Reference is now made to FIGS. 9-11, which illustrate a notch filter 302 that is an embodiment of notch filter 102. According to some embodiments notch filter 302 comprises a first mirror 320 (also referred to herein as a distal mirror); and a piezoelectric actuator 330 mounted through the side of mounting block 334. An upper wedge 350 may be attached on one side of an actuator 330. Upper wedge 350 may be slidably positioned on top of lower wedge 352. Lower wedge 352 may comprise guiding pins 354 and springs 356 to enable smooth sliding of upper wedge 350 up or down lower wedge 352. In some embodiments, as schematically shown in FIG. 11, a wedge rail 358 may be provided on which upper wedge 350 is mounted and moved. Distal mirror 320 is mounted on the upper surface 353 of upper wedge 350. A second mirror 322 (also referred to herein as proximal mirror) may be mounted on block 334 such that first mirror 320 and second mirror 322 face each other. As actuator 330 is operably engaged (e.g., to extend or retract), upper wedge 350 slides up or down lower wedge 352 to thereby move first mirror 320 closer or further away from second mirror 322 to thereby change the distance between first mirror 320 and second mirror 322. This way, the wavelength is changed that is not reflected between mirrors 320 and 322 to thereby notch out the non-reflected wavelength.

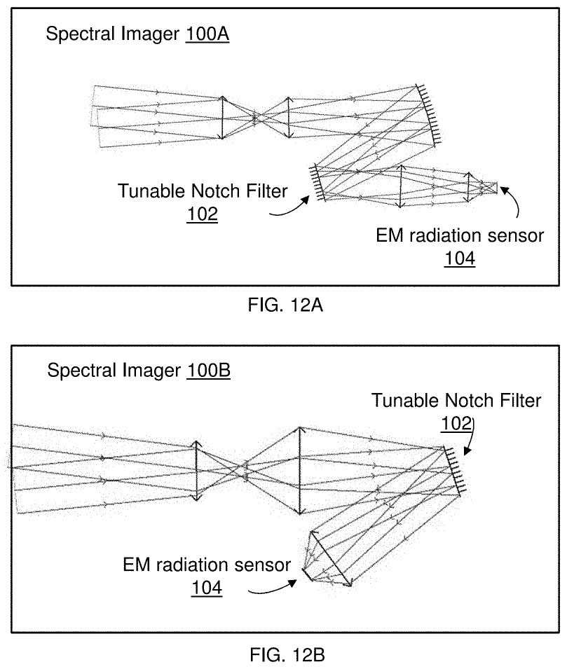

Referring now to FIG. 12A, a schematic example optical design of a spectral imager 100A is shown. Further referring now to FIG. 12B, a schematic example of an optical design of another spectral imager 100B is shown.

### ADDITIONAL EXAMPLES

Example 1 includes a method for remotely sensing a change in one or more transmission characteristics of an EM radiation propagation medium through which EM radiation propagates that is radiated from one or more objects in a scene, the method comprising: providing a spectral imager comprising a notch filter; capturing, by the imager, a plurality of scene images for each one of at least two notched bands; comparing a value relating at least one captured image with a value relating to at least one other captured image to determine the presence and/or a location of changes in the imaged scene.

Example 2 includes the subject matter of Example 1 and, optionally, wherein the notch filter is implemented by sensing EM radiation reflected from a Fabry-Pérot interferometer (FPI).

Example 3 includes the subject matter of Example 1 and/or of Example 2 and, optionally, wherein the comparing comprises: generating, respectively for each k notched wavelength, reference image data based on the at least one selected image; generating, respectively for each k notched wavelength, an observation image data based on the at least one other selected image; integrating reference image data across the different k notched wavelengths to obtain a global reference image; integrating observation image data across the different k notched wavelengths to obtain a global observation image; and comparing the global observation image with the global reference image to obtain a comparison result to determine whether changes occurred the scene.

Example 4 includes the subject matter of Example 3 and, optionally, wherein the generating of reference and observation image data comprises processing the one or more captured reservation and observation images.

Example 5 includes the subject matter of any one or more of Examples 1 to 4 and, optionally, selecting N1 reference and N2 observation images, wherein N2>>N1.

Example 6 includes the subject matter of Example 4 or Example 5 and, optionally, wherein the number of images selected as reference and/or observation images increases the greater the complexity and/or the expected changes of the scene being imaged.

Example 7 includes the subject matter of any one or more of the Examples 1 to 6 and, optionally, if it is determined that a change relating to cloud material occurred in a field-of-view (FOV) of the scene: performing spectral analysis of the FOV based on a selection of pixels of the one or more observation images, the selection of pixels representing the FOV.

Example 8 includes the subject matter of Example 7 and, optionally, wherein the spectral analysis is performed by employing a Generalized Likelihood Ratio Test.

Example 9 concerns an imager comprising: a notch filter for notching out one or more wavelengths of a EM radiation received from a scene; an imager for generating reference and observation images descriptive of the filtered EM radiation; a memory for storing one or more captured images descriptive of EM radiation received from a scene; and a processor configured to: compare a value relating to at least one captured image with a value relating to at least one other captured image to obtain a comparison result for detecting changes in the EM radiation propagation medium of the imaged scene.

Example 10 includes the subject matter of Example 9 and, optionally, wherein the comparing of the one or more reference images with the one or more observation images comprises: processing, per notched wavelength, the at least one selected image to obtain reference image data; processing, per notched wavelength, the at least one other selected image to obtain observation image data; integrating, across the k notched wavelengths, the reference image data, to obtain a global reference image; integrating, across the k notched wavelengths, the observation image data to obtain a global observation image; and comparing the global observation image with the global reference image to obtain the comparison result.

Example 11 includes the subject matter of the Examples 9 and/or 10 and, optionally, wherein the processor is further configured to determine whether the comparison result meets a cloud detection criterion.

Example 12 includes the subject matter of Example 11 and, optionally, wherein the notch filter comprises: a proximal mirror that is positioned proximal to the imaged scene surface; a distal mirror that is positioned distal to the imaged scene surface; and an actuator operable to adjust a gap between the first and the second mirror for implementing with the proximal and distal mirror a Fabry-Perot interferometer.

Example 13 includes the subject matter of Example 12 and, optionally, wherein the actuator is positioned behind the distal mirror.

Example 14 includes the subject matter of any one or more of the Examples 9 to 13 and, optionally, wherein the notch filter is implemented by sensing EM radiation reflected from a Fabry-Pérot interferometer (FPI).

Example 15 includes the subject matter of any one or more of the Examples 9 to 14 and, optionally, wherein the comparing further comprises, if a detected change in the scene meets the cloud detection criterion: determining the location of the change in the imaged scene.

Example 16 includes the subject matter of any one or more of the Examples 9 to 15 and, optionally, wherein the processing comprises: averaging; determining a medium; filtering, or a combination thereof, in relation to the at least one the at least one selected image and/or of the at least one other selected image.

Example 17 includes the subject matter of any one or more of the Examples 9 to 16 and, optionally, if it is determined that a change detected in a FOV of the imaged scene meets a cloud detection criterion: performing spectral analysis of the FOV based on a selection of pixels of the one or more observation images, the selection of pixels representing the FOV.

Example 18 includes the subject matter of Example 17 and, optionally, wherein the spectral analysis is performed by employing a Generalized Likelihood Ratio Test.

Example 19 pertains to an imager comprising:

a tunable notch filter for notching out one or more wavelengths of EM radiation received from a scene; an EM radiation sensor for generating reference and observation images descriptive of the filtered EM radiation; and circuitry that is configured to store one or more captured images descriptive of EM radiation received from a scene; and compare a value relating to at least one captured image with a value relating to at least one other captured image to obtain a comparison result for detecting changes in the EM radiation propagation medium of the imaged scene.

It is noted that the expressions “concurrently”, “simultaneously”, “in real-time”, “constant” as used herein may also encompass, respectively, the meaning of the expression “substantially concurrently”, “substantially simultaneously”, “substantially in real-time” and “substantially constant”.

Any digital computer system, module and/or engine exemplified herein can be configured or otherwise programmed to implement a method disclosed herein, and to the extent that the system, module and/or engine is configured to implement such a method, it is within the scope and spirit of the disclosure. Once the system, module and/or engine are programmed to perform particular functions pursuant to computer readable and executable instructions from program software that implements a method disclosed herein, it in effect becomes a special purpose computer particular to embodiments of the method disclosed herein. The methods and/or processes disclosed herein may be implemented as a computer program product that may be tangibly embodied in an information carrier including, for example, in a non-transitory tangible computer-readable and/or non-transitory tangible machine-readable storage device. The computer program product may directly loadable into an internal memory of a digital computer, comprising software code portions for performing the methods and/or processes as disclosed herein.

Additionally or alternatively, the methods and/or processes disclosed herein may be implemented as a computer program that may be intangibly embodied by a computer readable signal medium. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a non-transitory computer or machine-readable storage device and that can communicate, propagate, or transport a program for use by or in connection with apparatuses, systems, platforms, methods, operations and/or processes discussed herein.

The terms “non-transitory computer-readable storage device” and “non-transitory machine-readable storage device” encompasses distribution media, intermediate storage media, execution memory of a computer, and any other medium or device capable of storing for later reading by a computer program implementing embodiments of a method disclosed herein. A computer program product can be deployed to be executed on one computer or on multiple computers at one site or distributed across multiple sites and interconnected by one or more communication networks.

These computer readable and executable instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable and executable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable and executable instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

In the discussion, unless otherwise stated, adjectives such as “substantially” and “about” that modify a condition or relationship characteristic of a feature or features of an embodiment of the invention, are to be understood to mean that the condition or characteristic is defined to within tolerances that are acceptable for operation of the embodiment for an application for which it is intended.

It is important to note that the method may include is not limited to those diagrams or to the corresponding descriptions. For example, the method may include additional or even fewer processes or operations in comparison to what is described in the figures. In addition, embodiments of the method are not necessarily limited to the chronological order as illustrated and described herein.

Discussions herein utilizing terms such as, for example, “processing”, “computing”, “calculating”, “determining”, “establishing”, “analyzing”, “checking”, “estimating”, “deriving”, “selecting”, “inferring” or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes. The term determining may, where applicable, also refer to “heuristically determining”.

It should be noted that where an embodiment refers to a condition of “above a threshold”, this should not be construed as excluding an embodiment referring to a condition of “equal or above a threshold”. Analogously, where an embodiment refers to a condition “below a threshold”, this should not to be construed as excluding an embodiment referring to a condition “equal or below a threshold”. It is clear that should a condition be interpreted as being fulfilled if the value of a given parameter is above a threshold, then the same condition is considered as not being fulfilled if the value of the given parameter is equal or below the given threshold. Conversely, should a condition be interpreted as being fulfilled if the value of a given parameter is equal or above a threshold, then the same condition is considered as not being fulfilled if the value of the given parameter is below (and only below) the given threshold.

It should be understood that where the claims or specification refer to “a” or “an” element and/or feature, such reference is not to be construed as there being only one of that element. Hence, reference to “an element” or “at least one element” for instance may also encompass “one or more elements”.

Terms used in the singular shall also include the plural, except where expressly otherwise stated or where the context otherwise requires.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Unless otherwise stated, the use of the expression “and/or” between the last two members of a list of options for selection indicates that a selection of one or more of the listed options is appropriate and may be made, and may be used interchangeably with the expressions “at least one of the following”, “any one of the following” or “one or more of the following”, followed by the list of options.

It is appreciated that certain features of the invention, which are, for clarity, described in the context of separate embodiments or example, may also be provided in combination in a single embodiment. Conversely, various features of the invention, which are, for brevity, described in the context of a single embodiment, example and/or option, may also be provided separately or in any suitable sub-combination or as suitable in any other described embodiment, example or option of the invention. Certain features described in the context of various embodiments, examples and/or optional implementation are not to be considered essential features of those embodiments, unless the embodiment, example and/or optional implementation is inoperative without those elements.

The number of elements shown in the Figures should by no means be construed as limiting and is for illustrative purposes only.

As used herein, if a machine (e.g., a processor) is described as “configured to” or “operable to” perform a task (e.g., configured to cause application of a predetermined field pattern), then, at least in some embodiments, the machine may include components, parts, or aspects (e.g., software) that enable the machine to perform a particular task. In some embodiments, the machine may perform this task during operation. Similarly, when a task is described as being done “in order to” establish a target result (e.g., in order to apply a plurality of electromagnetic field patterns to the object), then, at least in some embodiments, carrying out the task may accomplish the target result.

Throughout this application, various embodiments may be presented in and/or relate to a range format. It should be understood that the description in range format is merely for convenience and brevity and should not be construed as an inflexible limitation on the scope of the embodiments. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Where applicable, whenever a numerical range is indicated herein, it is meant to include any cited numeral (fractional or integral) within the indicated range.

The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

While the invention has been described with respect to a limited number of embodiments, these should not be construed as limitations on the scope of the invention, but rather as exemplifications of some of the embodiments.

What is claimed is:

1. A method for remotely sensing a change in one or more transmission characteristics of an electromagnetic (EM) radiation propagation medium through which EM radiation propagates that is radiated from one or more objects in a scene, the method comprising:
providing a spectral imager comprising a tunable notch filter;
capturing, by the imager, a plurality of scene images for each one of at least two notched bands transmitted by the tunable notch filter; and
comparing a value relating to at least one captured image of the plurality of scene images with a value relating to at least one other captured image of the plurality of scene images to determine the presence and/or a location of changes in the imaged scene.

2. The method of claim 1, wherein the tunable notch filter is implemented by sensing EM radiation reflected from a Fabry-Pérot interferometer (FPI).

3. The method of claim 1, wherein the comparing comprises:
generating, respectively for each k notched wavelength, reference image data based on the at least one selected image,
generating, respectively for each k notched wavelength, an observation image data based on the at least one other selected image,
integrating reference image data across the different k notched wavelengths to obtain a global reference image,
integrating observation image data across the different k notched wavelengths to obtain a global observation image, and
comparing the global observation image with the global reference image to obtain a comparison result to determine whether changes occurred the scene.

4. The method of claim 3, wherein the generating of reference and observation image data comprises processing the one or more captured global reference and observation images.

5. The method according claim 1, further comprising selecting N1 reference and N2 observation images, wherein N2>>N1.

6. The method of claim 5, wherein the number of images selected as reference and/or observation images increases the greater the complexity and/or the expected changes of the scene being imaged.

7. The method of claim 1, further comprising, if it is determined that a change relating to cloud material occurred in a field-of-view (FOV) of the scene, performing spectral analysis of the FOV based on a selection of pixels of the one or more observation images, the selection of pixels representing the FOV.

8. The method of claim 7, wherein the spectral analysis is performed by employing a Generalized Likelihood Ratio Test.

9. An imager comprising:
a tunable notch filter for notching out one or more wavelengths of EM radiation received from a scene;
an EM radiation sensor for generating reference and observation images descriptive of the EM radiation filtered by the tunable notch filter;
a memory for storing one or more captured images descriptive of EM radiation received from a scene; and
a processor configured to compare a value relating to at least one captured reference image with a value relating to at least one observation image to obtain a comparison result for detecting changes in the EM radiation propagation medium of the imaged scene.

10. The imager of claim 9, wherein the comparing of the one or more reference images with the one or more observation images comprises:
processing, per notched wavelength, the at least one selected image to obtain reference image data,
processing, per notched wavelength, the at least one other selected image to obtain observation image data,
integrating, across the k notched wavelengths, the reference image data, to obtain a global reference image,
integrating, across the k notched wavelengths, the observation image data to obtain a global observation image, and
comparing the global observation image with the global reference image to obtain the comparison result.

11. The imager of claim 9, wherein the processor is further configured to determine whether the comparison result meets a cloud detection criterion.

12. The imager of claim 10, wherein the processor is further configured to determine whether the comparison result meets a cloud detection criterion

13. The imager of claim 9, wherein the tunable notch filter comprises:
a proximal mirror that is positioned proximal to the imaged scene surface,
a distal mirror that is positioned distal to the imaged scene surface, and
an actuator operable to adjust a gap between the first and the second mirror for implementing with the proximal and distal mirror a Fabry-Perot interferometer.

14. The imager of claim 13, wherein the actuator is positioned behind the distal mirror.

15. The imager of claim 9, wherein the tunable notch filter is implemented by sensing EM radiation reflected from a Fabry-Pérot interferometer (FPI).

16. The imager of claim 9, wherein the comparing further comprises, if a detected change in the scene meets the cloud detection criterion, determining the location of the change in the imaged scene.

17. The imager of claim 9, wherein the processing of the selected image comprises one of: averaging, determining a medium, filtering, or any combination thereof, to obtain, per notched wavelength, the plurality of reference and observation images.

18. The imager according to claim 9 further comprising, if it is determined that a change detected in a FOV of the imaged scene meets a cloud detection criterion, performing spectral analysis of the FOV based on a selection of pixels of the one or more observation images, the selection of pixels representing the FOV.

19. The imager of claim 18, wherein the spectral analysis is performed by employing a Generalized Likelihood Ratio Test.

20. An imager comprising:
a tunable notch filter for notching out one or more wavelengths of EM radiation received from a scene;
an EM radiation sensor for generating reference and observation images descriptive of the filtered EM radiation; and
circuitry that is configured to store one or more captured images descriptive of EM radiation received from a scene; and to compare a value relating to at least one captured image with a value relating to at least one other captured image to obtain a comparison result for detecting changes in the EM radiation propagation medium of the imaged scene.
